(19) United States
(12) Patent Application Publication
(10) Pub. No.: US 2026/0031269 A1
(43) Pub. Date: Jan. 29, 2026

(54) COUPLED INDUCTORS AND ASSOCIATED SYSTEMS

(71) Applicant: Analog Devices, Inc., Wilmington, MA (US)

(72) Inventor: Vikas Paduvalli, San Jose, CA (US)

(21) Appl. No.: 18/781,496

(22) Filed: Jul. 23, 2024

(51) Int. Cl. H01F 27/30; H01F 27/24; H02M 1/14; H02M 3/04

(52) U.S. Cl. CPC H01F 27/306; H01F 27/24; H02M 1/14; H02M 3/04

(57) ABSTRACT

A coupled inductor includes a base magnetic structure, a top magnetic plate, a first winding, and a second winding. The base magnetic structure includes a base magnetic plate, a supporting magnetic element, a first open circuit inductance (OCL) magnetic element, a second OCL magnetic element, a first short circuit inductance (SCL) magnetic element, and a second SCL magnetic element. The top magnetic plate is disposed on the supporting magnetic element such that the top magnetic plate is separated from each of the first OCL magnetic element, the second OCL magnetic element, the first SCL magnetic element, and the second SCL magnetic element. The first winding is wound around the supporting magnetic element, and the second winding is wound around the supporting magnetic element. The first winding and the second winding have opposing orientations.

### BACKGROUND

A coupled inductor is an electromagnetic device including two or more windings that are magnetically coupled together. Coupled inductors are frequently used in multi-phase switching power converters, such as in a multi-phase buck converter, a multi-phase boost converter, or a multi-phase buck-boost converter, for energy storage and to achieve advantageous coupling of the converter phases. For example, use of a coupled inductor instead of multiple discrete inductors in a switching power converter may advantageously reduce ripple current magnitude and/or improve transient response.

### BRIEF DESCRIPTION OF THE DRAWINGS

FIG. 1 is a top plan view of a coupled inductor, according to an embodiment.

FIG. 2 is a front elevational view of the FIG. 1 coupled inductor.

FIG. 3 is a back elevational view of the FIG. 1 coupled inductor.

FIG. 4 is a right side elevational view of the FIG. 1 coupled inductor.

FIG. 5 is a left side elevational view of the FIG. 1 coupled inductor.

FIG. 6 is a cross-sectional view of the FIG. 1 coupled inductor taken along line A-A of FIG. 2.

FIG. 7 is a cross-sectional view of the FIG. 1 coupled inductor taken along line B-B of FIG. 2.

FIG. 8 is a cross-sectional view of the FIG. 1 coupled inductor taken along line C-C of FIG. 1.

FIG. 9 is a top plan view of a base magnetic structure of the FIG. 1 coupled inductor.

FIG. 10 is a front elevational view of the base magnetic structure of the FIG. 1 coupled inductor.

FIG. 11 is a back elevational view of the base magnetic structure of the FIG. 1 coupled inductor.

FIG. 12 is a right side elevational view of the base magnetic structure of the FIG. 1 coupled inductor.

FIG. 13 is a left side elevational view of the base magnetic structure of the FIG. 1 coupled inductor.

FIG. 14 is a top plan view of a first winding of the FIG. 1 coupled inductor.

FIG. 15 is a top plan view of a second winding of the FIG. 1 coupled inductor.

FIG. 16 is a top plan view of an alternate embodiment of the FIG. 1 coupled inductor including windings with extensions.

FIG. 17 is a front elevational view of the FIG. 16 coupled inductor.

FIG. 18 is a back elevational view of the FIG. 16 coupled inductor.

FIG. 19 is a cross-sectional view of the FIG. 16 coupled inductor taken along line D-D of FIG. 17.

FIG. 20 is a cross-sectional view of the FIG. 16 coupled inductor taken along line E-E of FIG. 17.

FIG. 21 is a top plan view of a first winding of the FIG. 16 coupled inductor.

FIG. 22 is a perspective view of the first winding of the FIG. 16 coupled inductor.

FIG. 23 is a top plan view of a second winding of the FIG. 16 coupled inductor.

FIG. 24 is a perspective view of the second winding of the FIG. 16 coupled inductor.

FIG. 25 is a top plan view of a base magnetic structure of the FIG. 16 coupled inductor.

FIG. 26 is a front elevational view of the base magnetic structure of the FIG. 16 coupled inductor.

FIG. 27 is a front elevational view of an electrical assembly including an instance of the FIG. 16 coupled inductor.

FIG. 28 is a top plan view of an alternate embodiment of the FIG. 1 coupled inductor where the windings have a c-shape instead of a u-shape.

FIG. 29 is a front elevational view of the FIG. 28 coupled inductor.

FIG. 30 is a cross-sectional view of the FIG. 28 coupled inductor taken along line F-F of FIG. 29.

FIG. 31 is a cross-sectional view of the FIG. 28 coupled inductor taken along line G-G of FIG. 29.

FIG. 32 is a top plan view of a first winding of the FIG. 28 coupled inductor.

FIG. 33 is a top plan view of a second winding of the FIG. 28 coupled inductor.

FIG. 34 is a top plan view of an electrical assembly including an instance of the FIG. 1 coupled inductor configured as a planar inductor, according to an embodiment.

FIG. 35 is a cross-sectional view of the FIG. 34 electrical assembly taken along line H-H of FIG. 34.

FIG. 36 is a top plan view of a printed circuit board (PCB) of the FIG. 34 electrical assembly.

FIG. 37 is a top plan view of an alternate embodiment of the FIG. 1 coupled inductor having a different magnetic core configuration than the FIG. 1 coupled inductor.

FIG. 38 is a cross-sectional view of the FIG. 37 coupled inductor taken along line I-I of FIG. 37.

FIG. 39 is a front elevational view of the FIG. 37 coupled inductor.

FIG. 40 is a back elevational view of the FIG. 37 coupled inductor.

FIG. 41 is a schematic diagram of a multi-phase switching power converter including an instance of the FIG. 1 coupled inductor, according to an embodiment.

### DETAILED DESCRIPTION OF THE EMBODIMENTS

It is generally desirable for a coupled inductor to have a small footprint and a small height. Additionally, it is frequently desirable for a coupled inductor to be configured in a manner which facilitates locating all associated switching stages on a common side of the coupled inductor. While coupled inductors meeting the aforementioned criteria have been developed, these conventional coupled inductors have significant drawbacks, such as requiring complicated manufacturing procedures to ensure proper gap thickness and/or requiring specialized tooling for magnetic core fabrication. For example, conventional coupled inductors typically require that gap thickness be set during manufacturing by applying a layer of glue or glass beads having a thickness equal to a desired gap thickness, and it is generally difficult to precisely control glue or glass bead layer thickness. As such, conventional coupled inductors may be difficult to manufacture, and it may be difficult to obtain precise gap thickness in conventional coupled inductors.

Disclosed herein are new coupled inductors which overcome the aforementioned drawbacks. The new coupled inductors include a base magnetic structure, a top magnetic plate, and two windings, where the two windings have opposing orientations. The windings are wound around a supporting magnetic element of the base magnetic structure, and the top magnetic plate is disposed on the supporting magnetic element. As such, the design of the new coupled inductors promotes ease of assembly, and in particular embodiments, gap thickness is a function of design of the base magnetic structure, thereby eliminating the need for gap thickness control during manufacturing. For example, in some embodiments, gap thickness is set during the design of the new coupled inductors, thereby eliminating the need to control gap thickness during manufacturing using a layer of glue or glass beads and enabling precise control of gap thickness. Furthermore, particular embodiments are compatible with widely used magnetic core tooling, thereby promoting low cost and ease magnetic core procurement. Moreover, the new coupled inductors enable independent adjustment of open circuit inductance (OCL) and short circuit inductance (SCL), which promotes versatility of the new coupled inductors. Additionally, some embodiments have a smaller height than conventional coupled inductors with similar electrical characteristics. Furthermore, certain embodiments have a low thermal resistance, such as to facilitate heat removal from solid-state devices in the vicinity of the coupled inductors. Moreover, some embodiments may be configured as a planar coupled inductor in a printed circuit board (PCB), thereby further promoting versatility of the new coupled inductors. As such, the new coupled inductors significantly advance the state of the art of power conversion using coupled inductors.

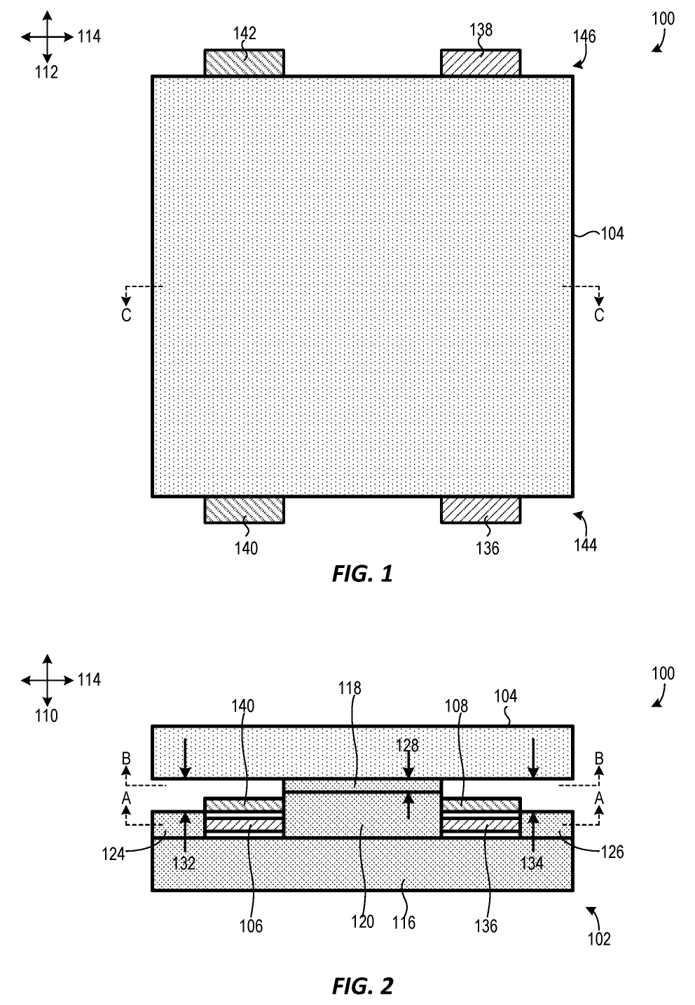

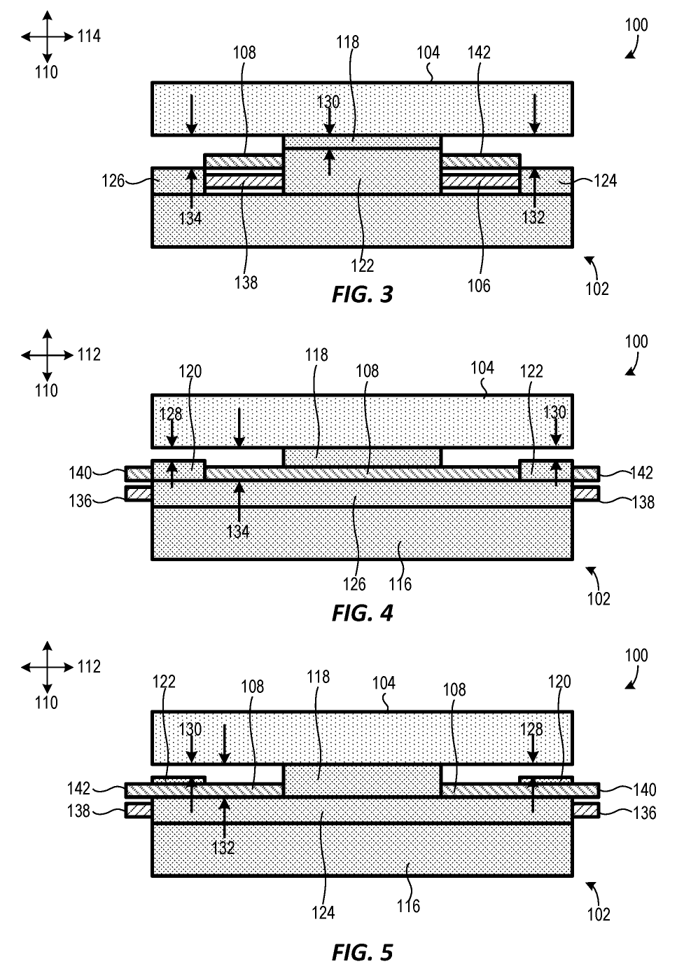

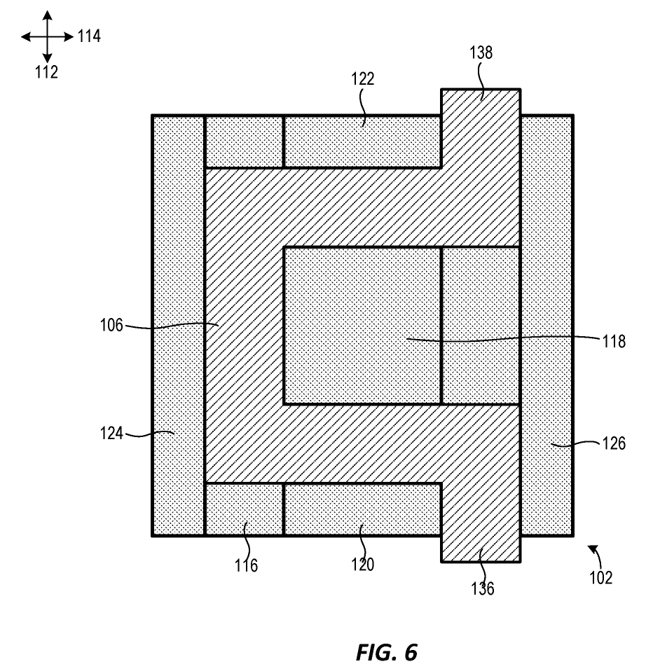

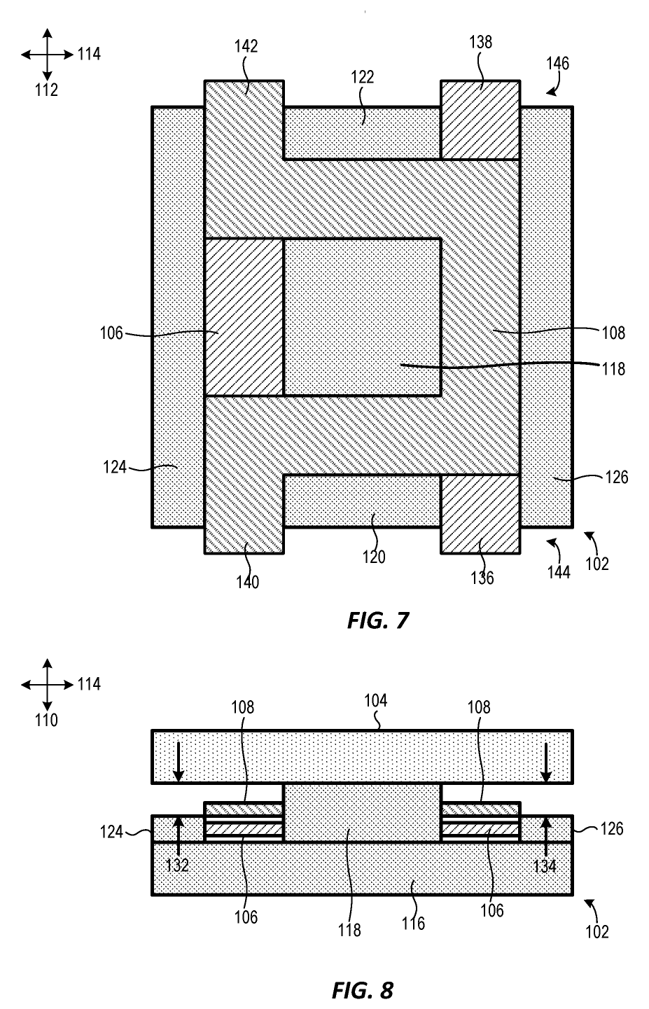

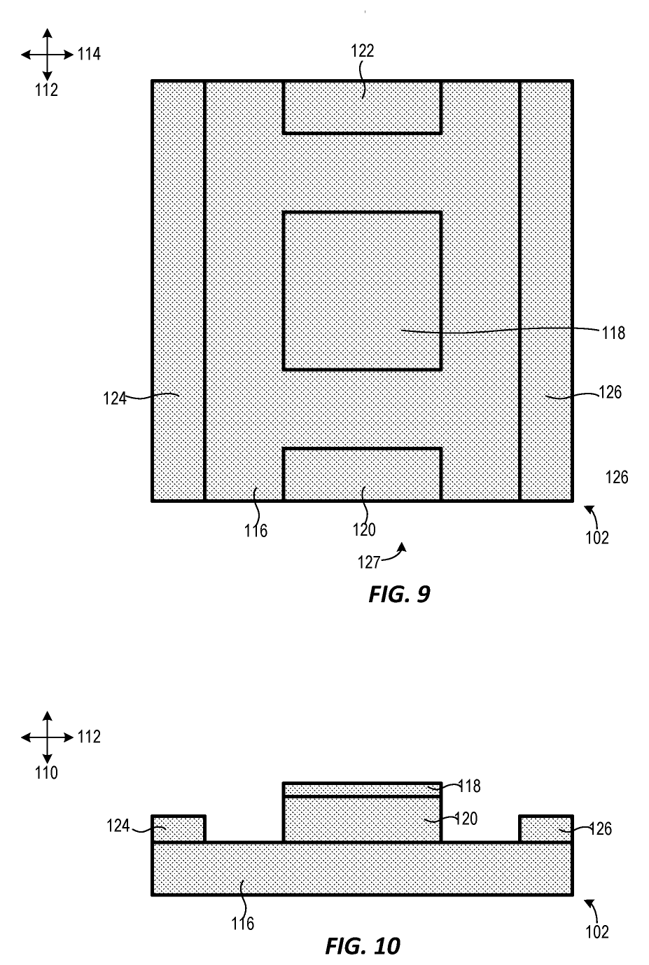

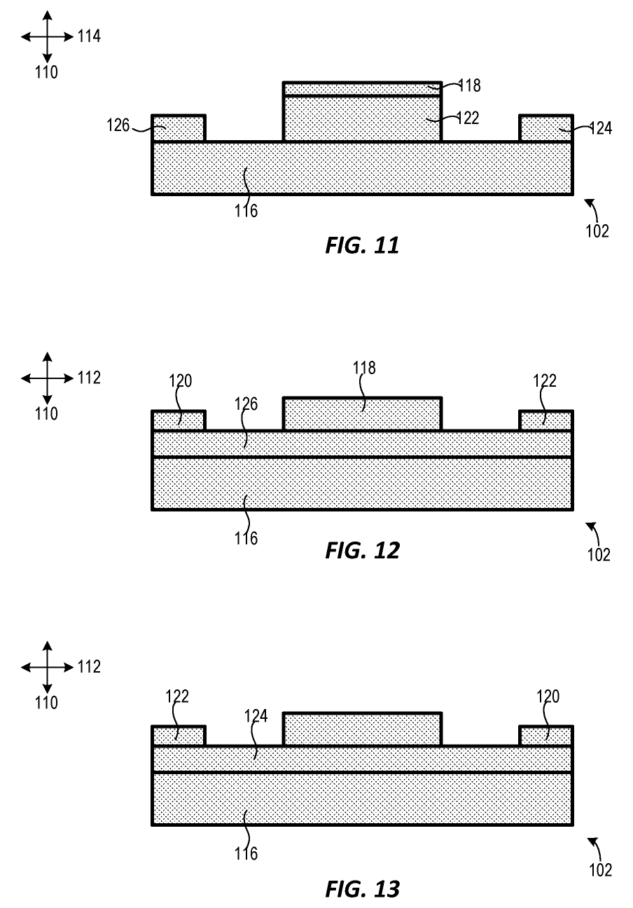

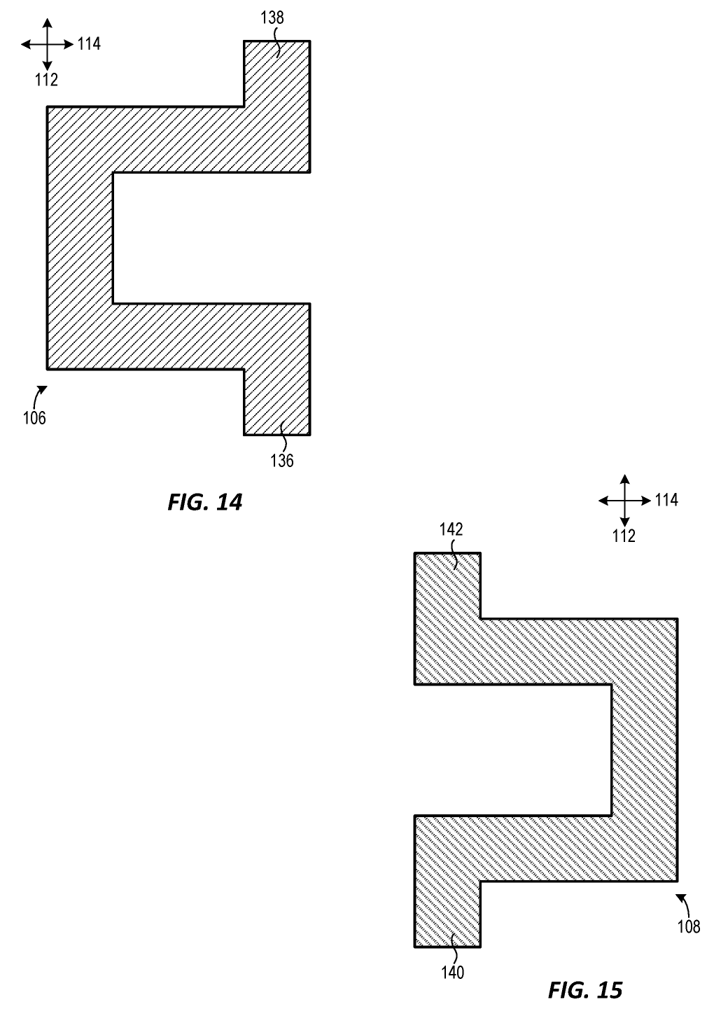

FIGS. 1-15 collectively illustrate a coupled inductor 100, where coupled inductor 100 is one embodiment of the new coupled inductors disclosed herein. Coupled inductor 100 includes a base magnetic structure 102, a top magnetic plate 104, a first winding 106, and a second winding 108. FIG. 1 is a top plan view of coupled inductor 100, FIG. 2 is a front elevational view of coupled inductor 100, FIG. 3 is a back elevational view of coupled inductor 100, FIG. 4 is a right side elevational view of coupled inductor 100, and FIG. 5 is a left side elevational view of coupled inductor 100. FIG. 6 is a cross-sectional view of coupled inductor 100 taken along line A-A of FIG. 2, FIG. 7 is a cross-sectional view of coupled inductor 100 taken along line B-B of FIG. 2, and FIG. 8 is a cross-sectional view of coupled inductor 100 taken along line C-C of FIG. 1. FIGS. 9-13 illustrate base magnetic structure 102 without the other elements of coupled inductor 100. Specifically, FIG. 9 is a top plan view of base magnetic structure 102, FIG. 10 is a front elevational view of base magnetic structure 102, FIG. 11 is a back elevational view of base magnetic structure 102, FIG. 12 is a right side elevational view of base magnetic structure 102, and FIG. 13 is a left side elevational view of base magnetic structure 102. FIG. 14 is a top plan view of first winding 106 separate from the other elements of coupled inductor 100, and FIG. 15 is a top plan view of second winding 108 separate from the other elements of coupled inductor 100.

The figures herein collectively illustrate three directions, i.e., a first direction 110, a second direction 112, and a third direction 114, which are orthogonal to each other. For example, second direction 112 is orthogonal to first direction 110, third direction 114 is orthogonal to each of first direction 110 and second direction 112, etc. Terms such as “base,” “side,” “top,” “front,” “back,” “right,” “left,” etc. are used herein for convenience and are not intended to require a particular orientation of the coupled inductors disclosed herein. For example, coupled inductor 100 could be placed upside down in an application such that top magnetic plate 104 is below base magnetic structure 102.

Base magnetic structure 102 and top magnetic plate 104 of coupled inductor 100 collectively form a magnetic core of coupled inductor 100. Accordingly, each of base magnetic structure 102 and top magnetic plate 104 is formed of a magnetic material, such as a ferrite magnetic material or a powder iron magnetic material within a binder. Base magnetic structure 102 includes a base magnetic plate 116, a supporting magnetic element 118, a first OCL magnetic element 120, a second OCL magnetic element 122, a first SCL magnetic element 124, and a second SCL magnetic element 126 (see, e.g., FIGS. 9-13). Each of base magnetic plate 116, supporting magnetic element 118, first OCL magnetic element 120, second OCL magnetic element 122, first SCL magnetic element 124, and second SCL magnetic element 126 extend from base magnetic plate toward top magnetic plate 104 in first direction 110 (see, e.g. FIGS. 2-5 and 8). As discussed further below, first OCL magnetic element 120 and second OCL magnetic element 122 are associated with respective gaps that control open circuit inductance of coupled inductor 100, and these magnetic elements are therefore referred to as “OCL” magnetic elements. Additionally, as discussed further below, first SCL magnetic element 124 and second SCL magnetic element 126 are associated with respective gaps that control short circuit inductance of coupled inductor 100, and these magnetic elements are therefore referred to as “SCL” magnetic elements. In certain embodiments, base magnetic structure 102 is a monolithic magnetic structure, i.e., base magnetic structure 102 is a single-piece magnetic structure including each of base magnetic plate 116, supporting magnetic element 118, first OCL magnetic element 120, second OCL magnetic element 122, first SCL magnetic element 124, and second SCL magnetic element 126.

First OCL magnetic element 120 and second OCL magnetic element 122 are separated from each other in second direction 112 (see, e.g., FIG. 9). Additionally, supporting magnetic element 118, first OCL magnetic element 120, and second OCL magnetic element 122 are disposed in a common row 127 in second direction 112 (see, FIG. 9). Additionally, first SCL magnetic element 124 and second SCL magnetic element 126 are separated from each other in third direction 114 (see, e.g., FIG. 9), and supporting magnetic element 118, first OCL magnetic element 120, and second OCL magnetic element 122 are disposed between first SCL magnetic element 124 and second SCL magnetic element 126 in third direction 114 (see, e.g., FIG. 9).

Top magnetic plate 104 is disposed on supporting magnetic element 118 in first direction 110 (see, e.g., FIGS. 2-5 and 8). For example, in certain embodiments, top magnetic plate 104 rests on, or is supported by, supporting magnetic element 118. The configuration of coupled inductor 100 supports ease of assembly of its magnetic core, e.g., in particular embodiments, top magnetic plate 104 merely needs be disposed on supporting magnetic element 118 to assemble the magnetic core of coupled inductor 100. Base magnetic structure 102 and top magnetic plate 104 additionally collectively form the following four gaps in the magnetic core of coupled inductor 100: (i) a first gap 128 separating first OCL magnetic element 120 from top magnetic plate 104 in first direction 110 (see, e.g., FIGS. 2, 4, and 5), (ii) a second gap 130 separating second OCL magnetic element 122 from top magnetic plate 104 in first direction 110 (see, e.g., FIGS. 3-5), (iii) a third gap 132 separating first SCL magnetic element 124 from top magnetic plate 104 in first direction 110 (see, e.g., FIGS. 2-5), and (iv) a fourth gap 134 separating second SCL magnetic element 126 from top magnetic plate 104 in first direction 110 (see, e.g., FIGS. 2-5). Each of the aforementioned gaps is filled with air or another material having a lower magnetic permeability than magnetic material forming base magnetic structure 102 and top magnetic plate 104.

OCL and SCL can advantageously be individually controlled in coupled inductor 100 by adjusting appropriate gaps. Specifically, OCL is a function of first gap 128 and second gap 130. For example, OCL can be increased by decreasing thickness of first gap 128 and second gap 130 in first direction 110, and OCL can be decreased by increasing thickness of first gap 128 and second gap 130 in first direction 110. Additionally, SCL is a function of third gap 132 and fourth gap 134. For example, SCL can be increased by decreasing thickness of third gap 132 and fourth gap 134 in first direction 110, and SCL can be decreased by increasing thickness of third gap 132 and fourth gap 134 in first direction 110. Importantly, thickness of each of first gap 128, second gap 130, third gap 132, and fourth gap 134 in first direction 110 is a function of the configuration of base magnetic structure 102, instead of a function of the assembly of coupled inductor 100. For example, thickness of first gap 128 in first direction 110 is a function of each of (i) how far first OCL magnetic element 120 extends from base magnetic plate 116 in first direction 110 and (ii) how far supporting magnetic element 118 extends from base magnetic plate 116 in first direction 110. As another example, thickness of third gap 132 in first direction 110 is a function of each of (i) how far first SCL magnetic element 124 extends from base magnetic plate 116 in first direction 110 and (ii) how far supporting magnetic element 118 extends from base magnetic plate 116 in first direction 110. As such, thickness of each of first gap 128, second gap 130, third gap 132, and fourth gap 134 in first direction 110 is set by the design of base magnetic structure 102, instead of by controlling thickness of a glue layer or a glass bead layer during manufacturing. Consequently, gap thickness control is not needed during assembly of coupled inductor 100, which promotes ease of assembly of coupled inductor 100 as well as precise control of gap thickness that cannot be realized by conventional coupled inductors requiring control of glue layer thickness or glass bead layer thickness during manufacturing.

First winding 106 has a first end 136 and an opposing second end 138, and second winding 108 has a first end 140 and an opposing second end 142 (see, e.g., FIGS. 14 and 15). Each of first winding 106 and second winding 108 is wound around supporting magnetic element 118, such that first winding 106 and second winding 108 are stacked in first direction 110. Accordingly, each of first winding 106 and second winding 108 is disposed between base magnetic plate 116 and top magnetic plate 104 in first direction 110, and each first winding 106 and second winding 108 is disposed between first SCL magnetic element 124 and second SCL magnetic element 126 in third direction 114. First winding 106 and second winding 108 are electrically isolated from each other in coupled inductor 100, such as by an insulating coating (not shown), such as varnish or a plastic material, applied to each winding, or by an insulating material (not shown) disposed between first winding 106 and second winding 108 in first direction 110. In particular embodiments, second winding 108 has the same configuration and first winding 106, or stated differently, each of first winding 106 and second winding 108 is the same type of winding. However, first winding 106 and second winding 108 are each wound around supporting magnetic element 118 such that first winding 106 and second winding 108 have opposing orientations when coupled inductor 100 in viewed cross-sectional in first direction 110.

For example, consider FIGS. 6 and 7, which are respective cross-sectional views of coupled inductor 100 viewed in first direction 110. As evident when comparing FIGS. 6 and 7, first winding 106 and second winding 108 have opposing orientations. For instance, each of first winding 106 and second winding 108 have a u-shape when viewed in first direction 110. However, the open portion of the u-shape faces right for first winding 106 as illustrated in FIG. 6, while open portion of the u-shape faces left for second winding 108, as illustrated in FIG. 7. As such, first winding 106 and second winding 108 have opposing orientations when viewed in first direction 110. As another example, second winding 108 is a mirror image of first winding 106, when each winding is viewed in first direction 110, which also indicates that first winding 106 and second winding 108 have opposing orientations. The fact that first winding 106 and second winding 108 have opposing orientations advantageously enables a respective switching stage to be electrically coupled to a respective end of each winding on a common side of coupled inductor 100, while still achieving the necessary magnetic coupling of first winding 106 and second winding 108 to realize the aforementioned benefits of using a coupled inductor instead of a discrete inductor, i.e., to reduce ripple current magnitude and/or improve transient response. For example, referring again to FIG. 1, a respective switching stage could be electrically coupled to each of first winding end 136 and first winding end 140 on front side 144 of coupled inductor 100, while achieving the necessary magnetic coupling of first winding 106 and second winding 108 to realize the aforementioned benefits of using a coupled inductor instead of a discrete inductor. As another example, a respective switching stage could be electrically coupled to each of second winding end 138 and second winding end 142 on back side 146 of coupled inductor 100, while achieving the necessary magnetic coupling of first winding 106 and second winding 108 to realize the aforementioned benefits of using a coupled inductor instead of a discrete inductor. In contrast, if first winding 106 and second winding 108 instead had a common orientation, it would be necessary for (i) one switching stage to be electrically coupled to one of first winding end 136 and first winding end 140 on front side 144 of coupled inductor 100 and (ii) one switching stage to be electrically coupled to one of second winding end 138 and second winding end 142 on back side 146 of coupled inductor 100, to achieve the necessary magnetic coupling of first winding 106 and second winding 108 to realize the aforementioned benefits of using a coupled inductor instead of a discrete inductor.

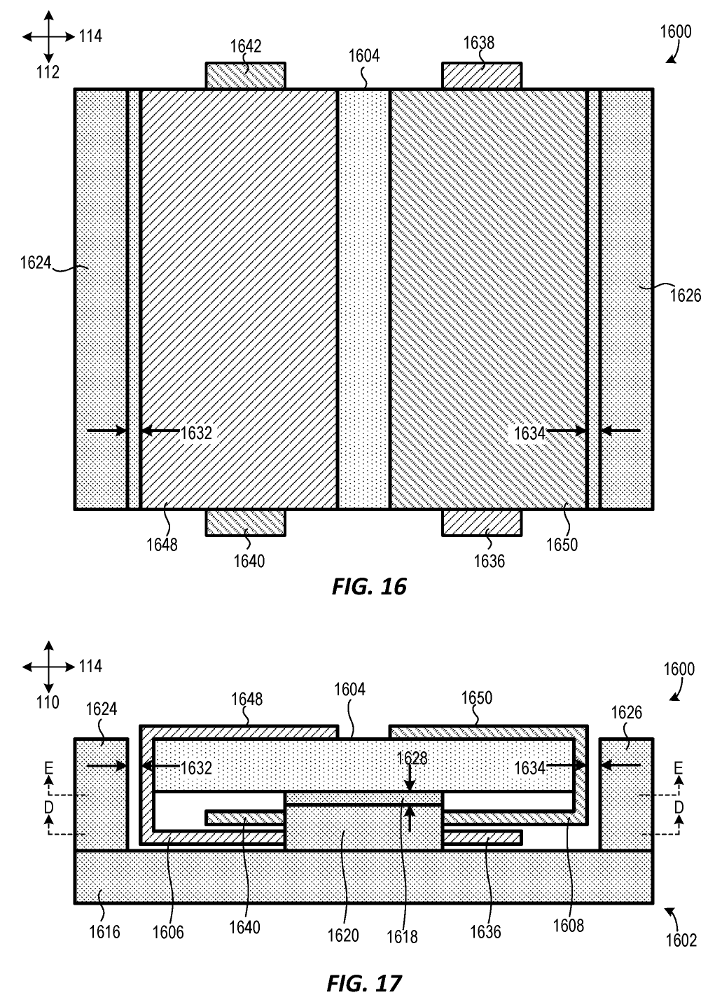

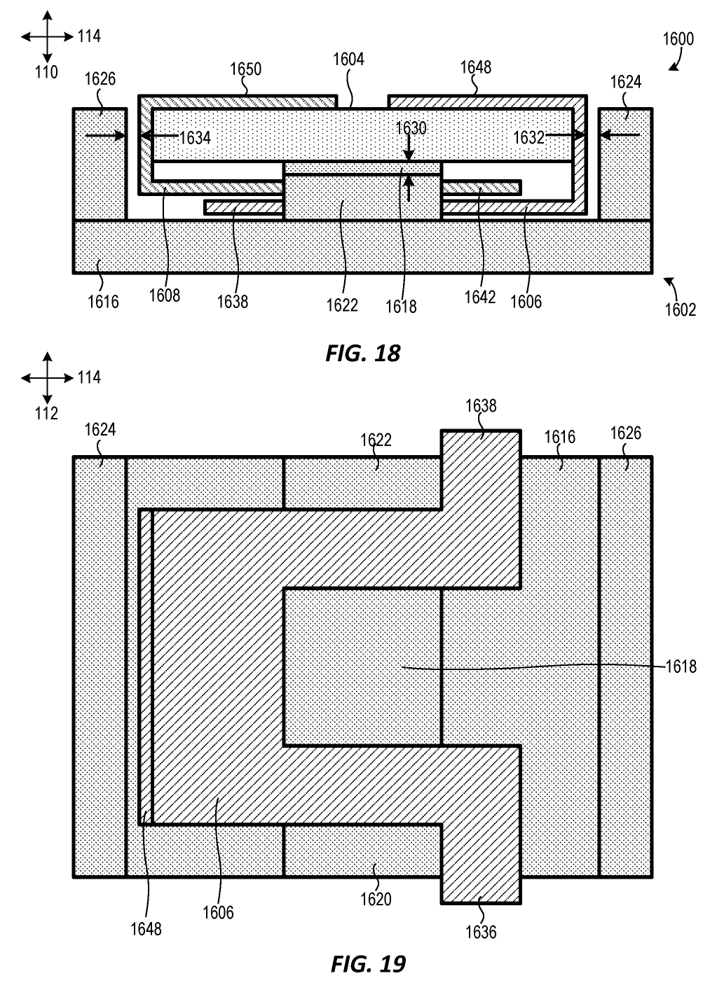

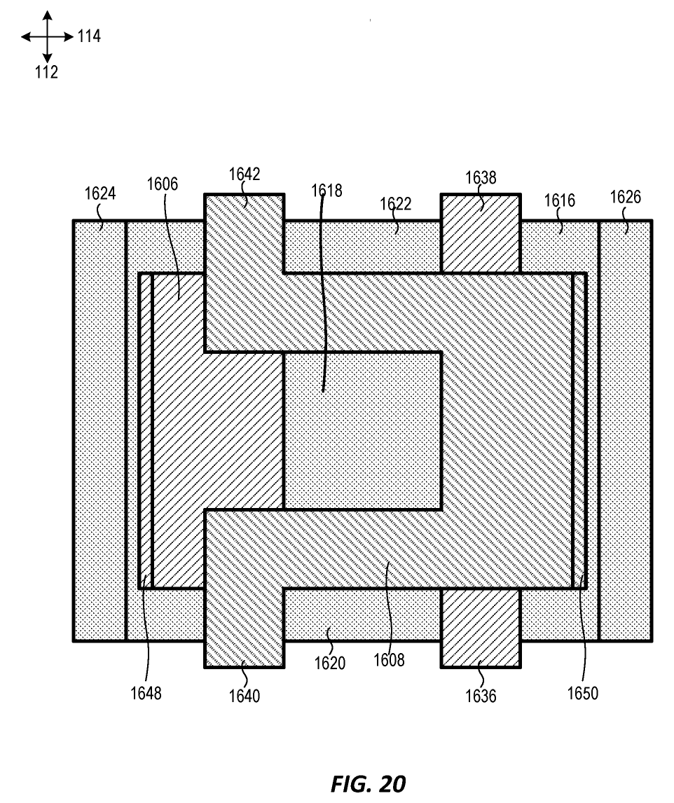

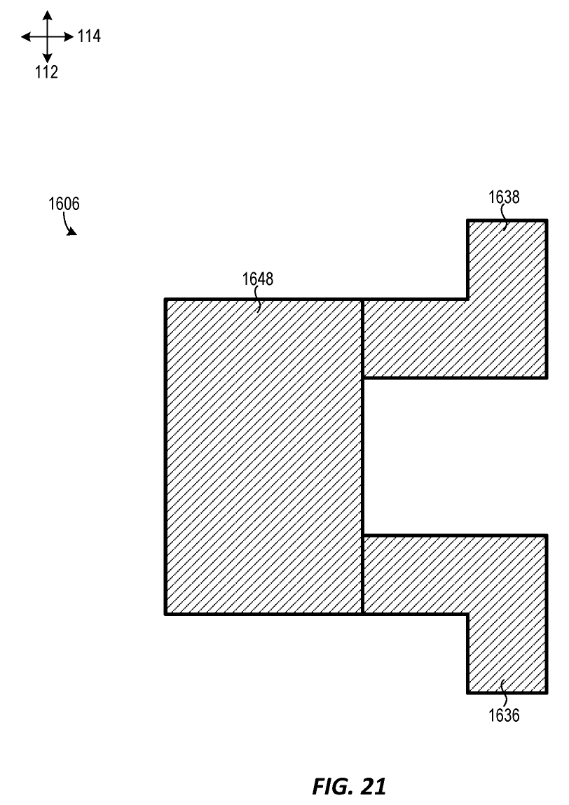

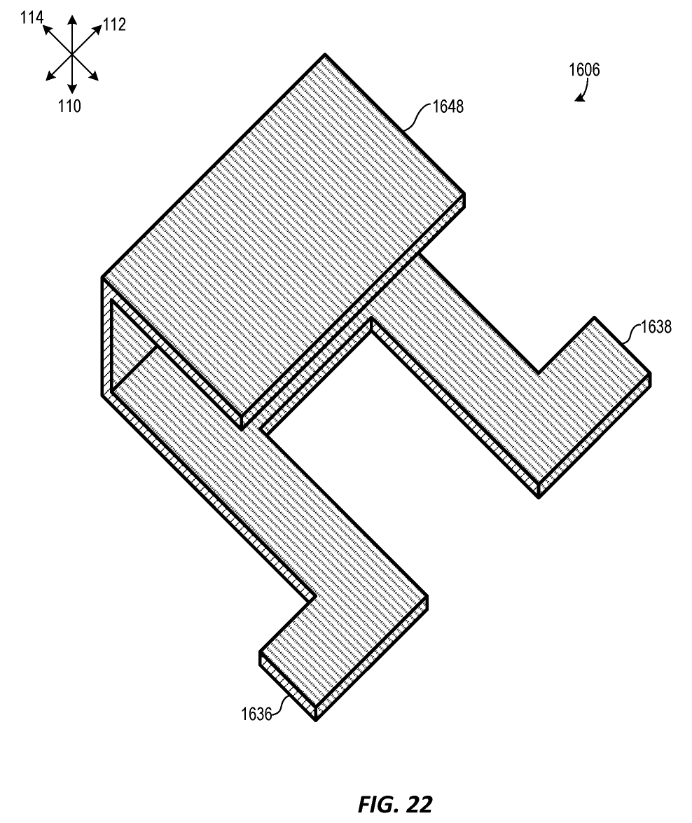

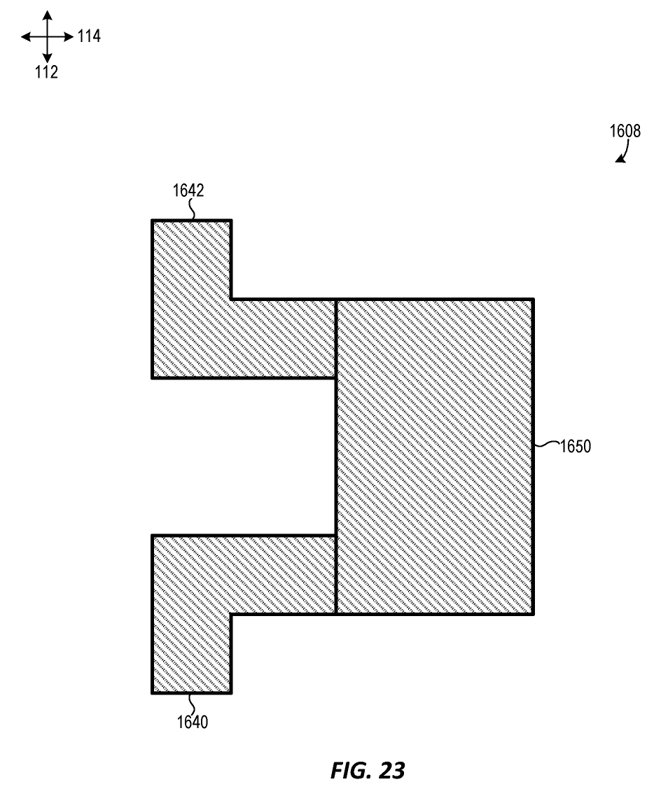

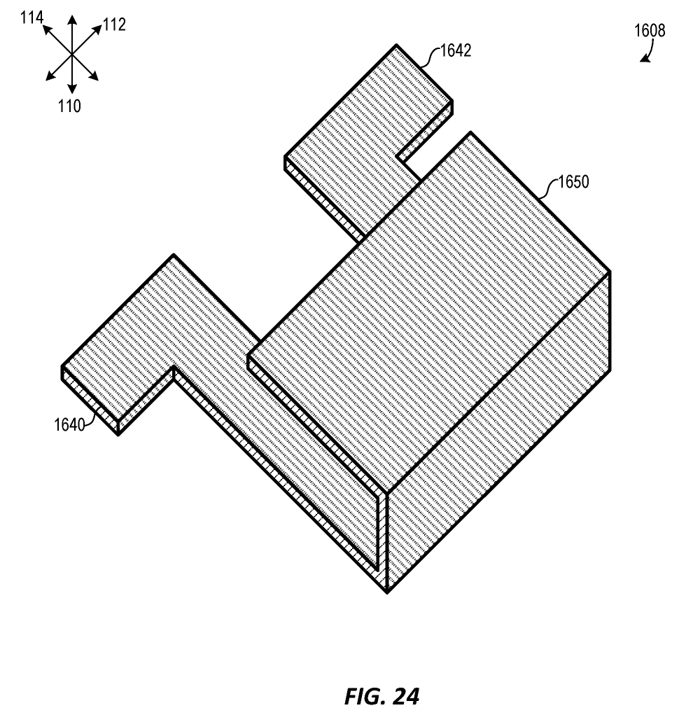

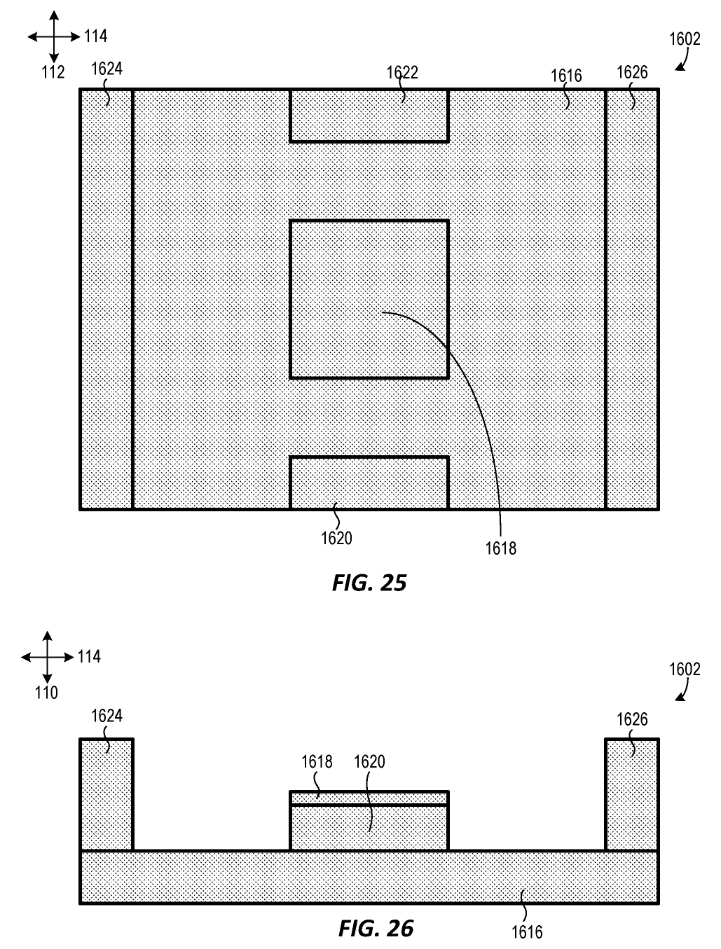

First winding 106 and second winding 108 could be modified to further include extensions to facilitate cooling coupled inductor 100 and/or cooling of components located nearby coupled inductor 100. For example, FIGS. 16-26 collectively illustrate a coupled inductor 1600, where coupled inductor 1600 is an alternate embodiment of coupled inductor 100 where the windings further include extensions to facilitate cooling. Specifically, FIG. 16 is a top plan view of coupled inductor 1600, FIG. 17 is a front elevational view of coupled inductor 1600, FIG. 18 is a back elevational view of coupled inductor 1600, FIG. 19 is a cross-sectional view of coupled inductor 1600 taken along line D-D of FIG. 17, and FIG. 20 is a cross-sectional view of coupled inductor 1600 taken along line E-E of FIG. 17. FIG. 21 is a top plan view of a first winding of coupled inductor 1600, and FIG. 22 is a perspective view of the first winding of coupled inductor 1600. FIG. 23 is a top plan view of a second winding of coupled inductor 1600, and FIG. 24 is a perspective view of the second winding of coupled inductor 1600. FIG. 25 is a top plan view of a base magnetic structure of coupled inductor 1600, and FIG. 26 is a side elevational view of the base magnetic structure of the FIG. 16 coupled inductor.

Coupled inductor 1600 includes a base magnetic structure 1602, a top magnetic plate 1604, a first winding 1606, and a second winding 1608, which are alternate embodiments of base magnetic structure 102, top magnetic plate 104, first winding 106, and second winding 108, respectively, of coupled inductor 100. Base magnetic structure 1602 includes a base magnetic plate 1616, a supporting magnetic element 1618, a first OCL magnetic element 1620, a second OCL magnetic element 1622, a first SCL magnetic element 1624, and a second SCL magnetic element 1626 (see, e.g., FIGS. 25 and 26). Base magnetic plate 1616, supporting magnetic element 1618, first OCL magnetic element 1620, and second OCL magnetic element 1622 are similar to base magnetic plate 116, supporting magnetic element 118, first OCL magnetic element 120, and second OCL magnetic element 122, respectively, of coupled inductor 100. First SCL magnetic element 1624 and second SCL magnetic element 1626 differ from first SCL magnetic element 124 and second SCL magnetic element 126, respectively, in that (i) first SCL magnetic element 1624 and second SCL magnetic element 1626 extend further from base magnetic plate 1616 in first direction 110, and (ii) first SCL magnetic element 1624 and second SCL magnetic element 1626 and further separated from each other in third direction 114.

Top magnetic plate 1604 is larger in second direction 112 and third direction 114 than top magnetic plate 104. Base magnetic structure 1602 and top magnetic plate 1604 collectively form the following four gaps in the magnetic core of coupled inductor 1600: (i) a first gap 1628 separating first OCL magnetic element 1620 from top magnetic plate 1604 in first direction 110 (see, FIG. 17), (ii) a second gap 1630 separating second OCL magnetic element 1622 from top magnetic plate 1604 in first direction 110 (see, FIG. 18), (iii) a third gap 1632 separating first SCL magnetic element 1624 from top magnetic plate 1604 in third direction 114 (see FIGS. 17 and 18), and (iv) a fourth gap 1634 separating second SCL magnetic element 1626 from top magnetic plate 1604 in third direction 114 (see FIGS. 17 and 18). Each of the aforementioned gaps is filled with air or another material having a lower magnetic permeability that magnetic material forming base magnetic structure 1602 and top magnetic plate 1604. First gap 1628 and second gap 1630 are similar to first gap 128 and second gap 130, respectively, of coupled inductor 100. Third gap 1632 and fourth gap 1634 serve the same purpose as third gap 132 and fourth gap 134, respectively, except that third gap 1632 and fourth gap 1634 separate respective elements in third direction 114 instead of in first direction 110.

First winding 1606 has a first end 1636 and an opposing second end 1638, and second winding 1608 has a first end 1640 and an opposing second end 1642 (see, e.g., FIGS. 21-24). Each of first winding 1606 and second winding 1608 is wound around supporting magnetic element 1618, such that first winding 1606 and second winding 1608 are stacked in first direction 110. First winding 1606 and second winding 1608 are electrically isolated from each other in coupled inductor 1600, such as by an insulating coating (not shown), such as varnish or a plastic, applied to each winding, or by an insulating material (not shown) disposed between first winding 1606 and second winding 1608 in first direction 110. In particular embodiments, second winding 1608 has the same configuration as first winding 1606, or stated differently, each of first winding 1606 and second winding 1608 is the same type of winding. However, first winding 1606 and second winding 1608 are each wound around supporting magnetic element 1618 such that first winding 1606 and second winding 1608 having opposing orientations when coupled inductor 1600 in view cross-sectionally in first direction 110 (see, e.g., FIGS. 19 and 20), for reasons analogous to those discussed above with respect to coupled inductor 100.

In contrast to first winding 106 and second winding 108 of coupled inductor 100, first winding 1606 includes a first extension 1648 and second winding 1608 includes a second extension 1650. First extension 1648 extends along a side of top magnetic plate 1604 and then over top magnetic plate 1604. Additionally, second extension 1650 extends along a side of top magnetic plate 1604 and then over top magnetic plate 1604. As such, top magnetic plate 1604 is disposed between first extension 1648 and base magnetic plate 1616 in first direction 110, and top magnetic plate 1604 is also disposed between second extension 1650 and base magnetic plate 1616 in first direction 110.

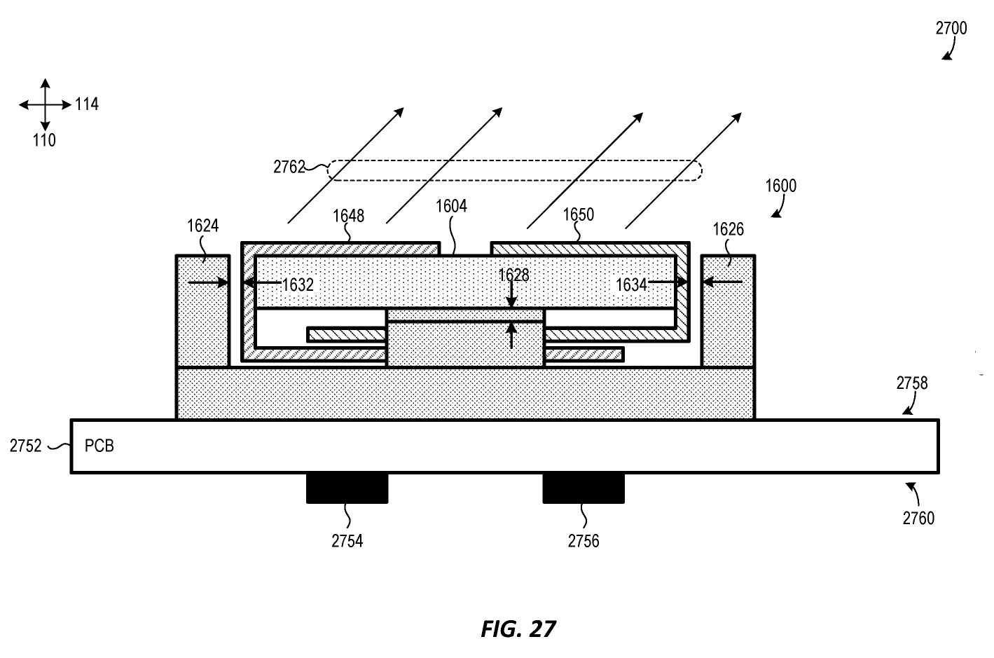

Applicant has found that first extension 1648 and second extension 1650 may be significantly helpful in transferring heat away from coupled inductor 1600 and/or components in the vicinity of coupled inductor 1600. For example, FIG. 27 is a front elevational view of an electrical assembly 2700 including an instance of coupled inductor 1600, a PCB 2752, a first solid-state device 2754 and a second solid-state device 2756. Coupled inductor 1600 is disposed on a top outer surface 2758 of PCB 2752, and each solid-state device 2754 and 2756 is disposed on a bottom outer surface 2760 of PCB 2752. In some embodiments, each solid-state device 2754 and 2756 is a respective switching stage electrically coupled to coupled inductor 1600. Each solid-state device 2754 and 2756 generates heat 2762, and first extension 1648 and second extension 1650 advantageously help transfer heat away from solid-state devices 2754 and 2756, as symbolically shown in FIG. 27 by first extension 1648 and second extension 1650 dissipating heat 2762. Applicant has conducted simulations which show that inclusion of extensions similar to extensions 1648 and 1650 may reduce junction to case thermal impedance of a solid-state device, such as solid state devices similar to those of FIG. 27, by approximately ten degrees Celsius. Electrical assembly 2700 could be modified to further include one of more heatsinks (not shown) on first extension 1648 and/or second extension 1650 to further facilitate transfer of heat away from solid-state devices 2754 and 2756.

The opposing ends of each winding of coupled inductor 100 and coupled inductor 1600 terminate on different sides of the coupled inductor. For example, as illustrated in FIG. 7, first end 136 of first winding 106 terminates on front side 144 of coupled inductor 100 while opposing second end 138 of first winding 106 terminates on back side 146 of coupled inductor 100. As another example, first end 140 of second winding 108 terminates on front side 144 of coupled inductor 100 while opposing second end 142 of second winding 108 terminates on back side 146 of coupled inductor 100. However, coupled inductor 100 or coupled inductor 1600 could be modified so that opposing ends of a given winding terminate on a common side of the coupled inductor.

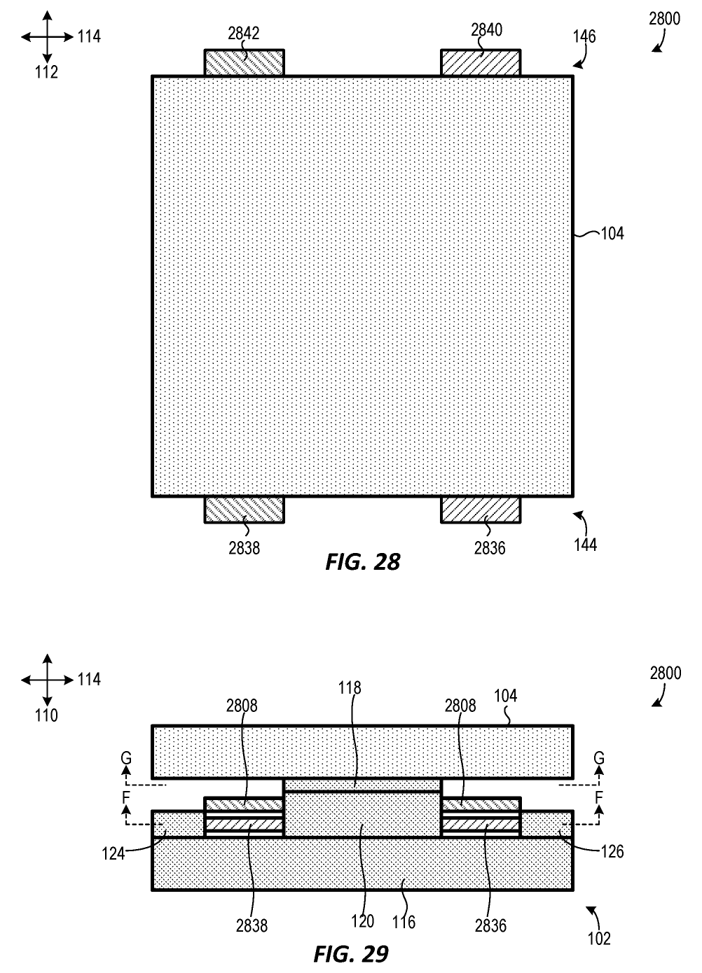

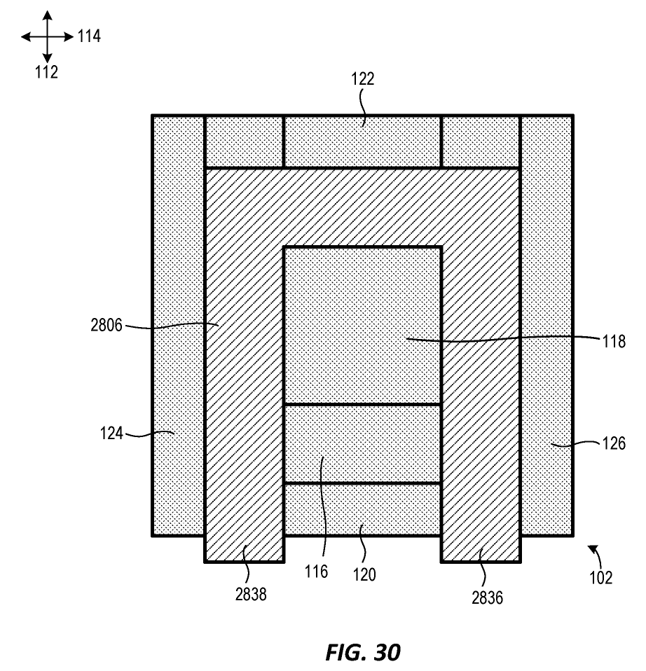

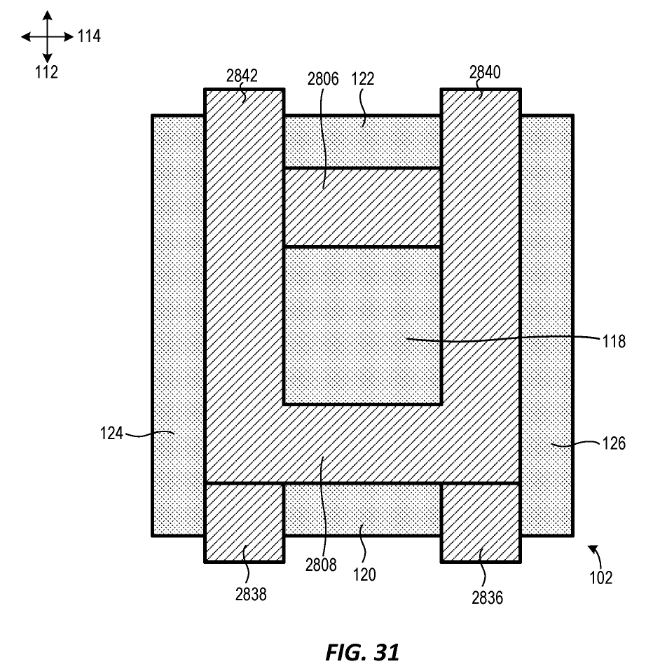

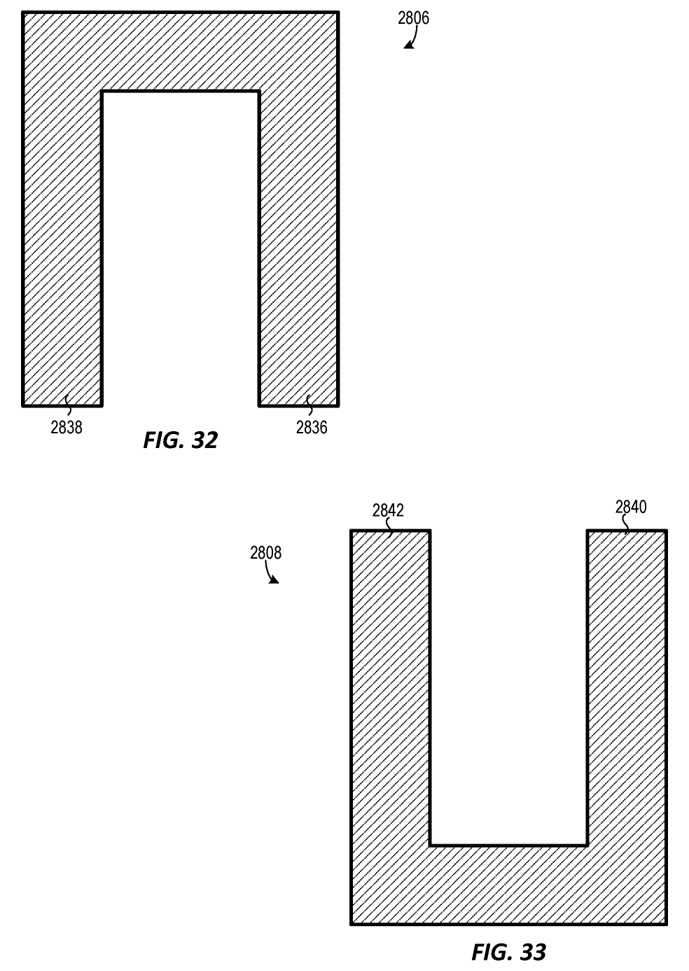

For example, FIG. 28 is a top plan view of a coupled inductor 2800, which is an alternate embodiment of coupled inductor 100 where opposing ends of a given winding terminate on a common side of the coupled inductor. FIG. 29 is a front elevational view of coupled inductor 2800, FIG. 30 is a cross-sectional view of coupled inductor 2800 taken along line F-F of FIG. 29, and FIG. 31 is a cross-sectional view of coupled inductor 2800 taken along line G-G of FIG. 29. FIG. 32 is a top plan view of a first winding 2806 of coupled inductor 2800, and FIG. 33 is a top plan view of a second winding 2808 of coupled inductor 2800. Coupled inductor 2800 differs from coupled inductor 100 in that (i) first winding 106 is replaced with first winding 2806 and (ii) second winding 108 is replaced with second winding 2808. First winding 2806 has a first end 2836 and an opposing second end 2838 (see, e.g., FIG. 32), and second winding 2808 has a first end 2840 and an opposing second end 2842 (see, e.g., FIG. 33).

First winding 2806 and second winding 2808 are each wound around supporting magnetic element 118 (see, e.g., FIGS. 30 and 31), and first winding 2806 and second winding 2808 have opposing orientations as seen when coupled inductor 2800 is viewed cross-sectionally in first direction 110. For instance, each of first winding 2806 and second winding 2808 have a c-shape when viewed in first direction 110. However, the open portion of the c-shape faces toward the bottom of the page for first winding 2806 as illustrated in FIG. 30, while open portion of the c-shape faces toward the top of the page for second winding 2808, as illustrated in FIG. 31. As such, first winding 2806 and second winding 2808 have opposing orientations when viewed in first direction 110.

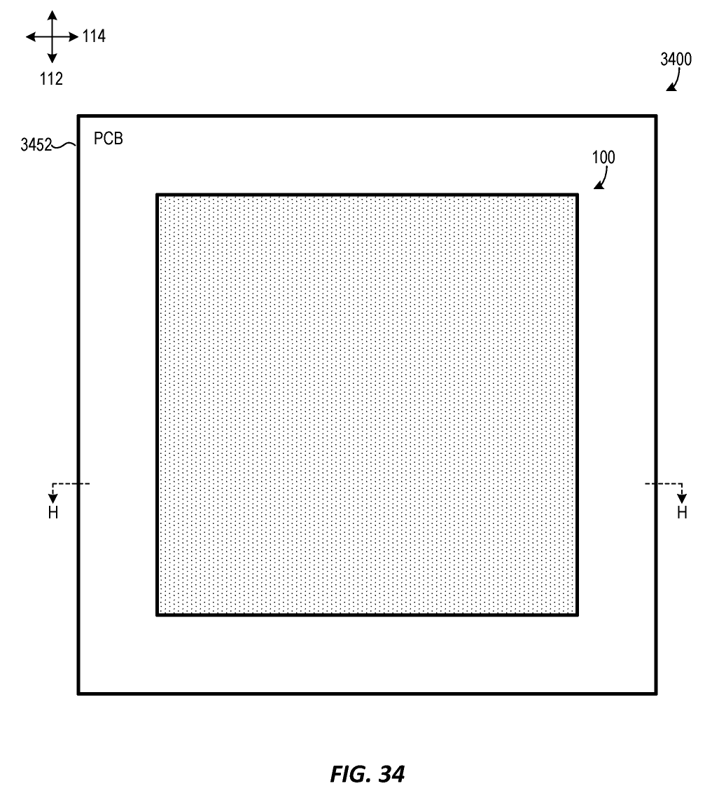

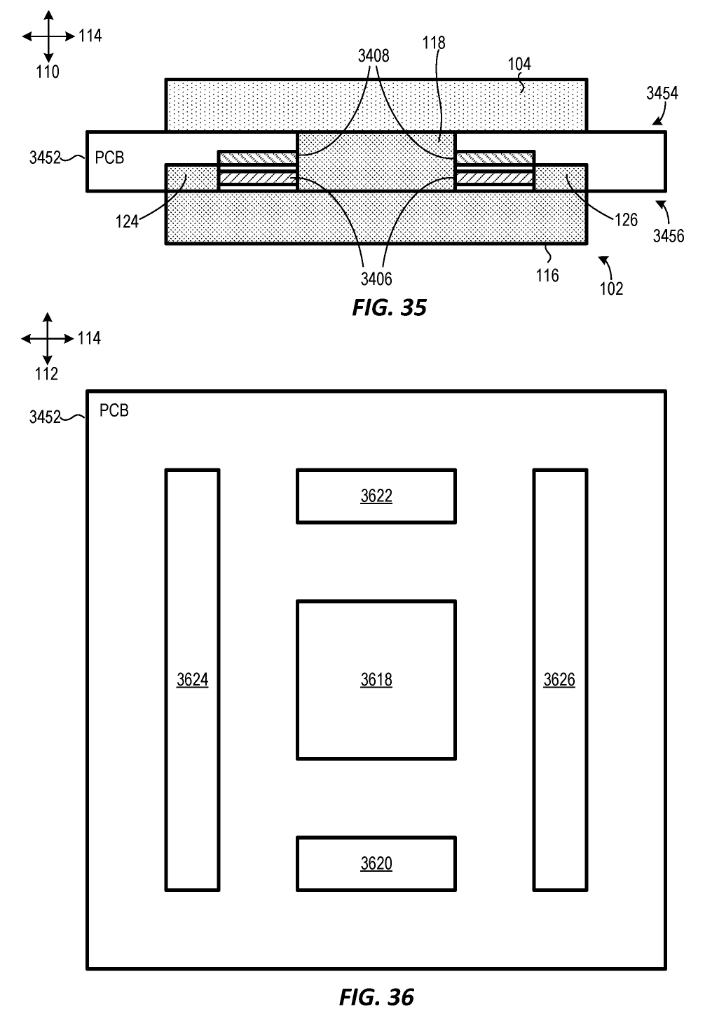

Any of the coupled inductors disclosed herein could be configured as planar coupled inductors in a PCB, where electrical conductors of the PCB, such as PCB traces, form the windings of the coupled inductor. For example, FIG. 34 is a top plan view of an electrical assembly 3400 including a PCB 3452 and an instance of coupled inductor 100 formed as a planar coupled inductor in PCB 3452. FIG. 35 is a cross-sectional view of electrical assembly 3400 taken along line H-H of FIG. 34. Top magnetic plate 104 is disposed on a top outer surface 3454 of PCB 3452, and base magnetic plate 116 of base magnetic structure 102 is disposed on a bottom outer surface 3456 of PCB 3452. Each of supporting magnetic element 118, first OCL magnetic element 120, second OCL magnetic element 122, first SCL magnetic element 124, and second SCL magnetic element 126 extend from base magnetic plate 116 into a respective aperture of PCB 3452 in first direction 110. First winding 106 is embodied by a first electrical conductor 3406 of PCB 3452, and second winding 108 is embodied by a second electrical conductor 3408 of PCB 3452, in electrical assembly 3400. FIG. 36 is a top plan view of PCB 3452 without coupled inductor 100. PCB 3452 forms apertures 3618, 3620, 3622, 3624, and 3626 for supporting magnetic element 118, first OCL magnetic element 120, second OCL magnetic element 122, first SCL magnetic element 124, and second SCL magnetic element 126, respectively.

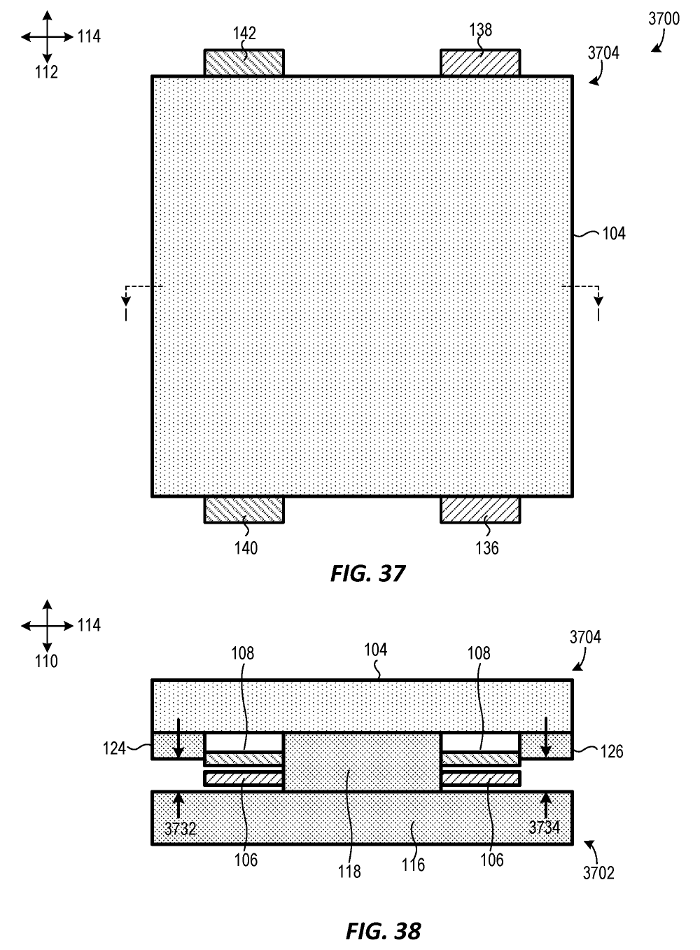

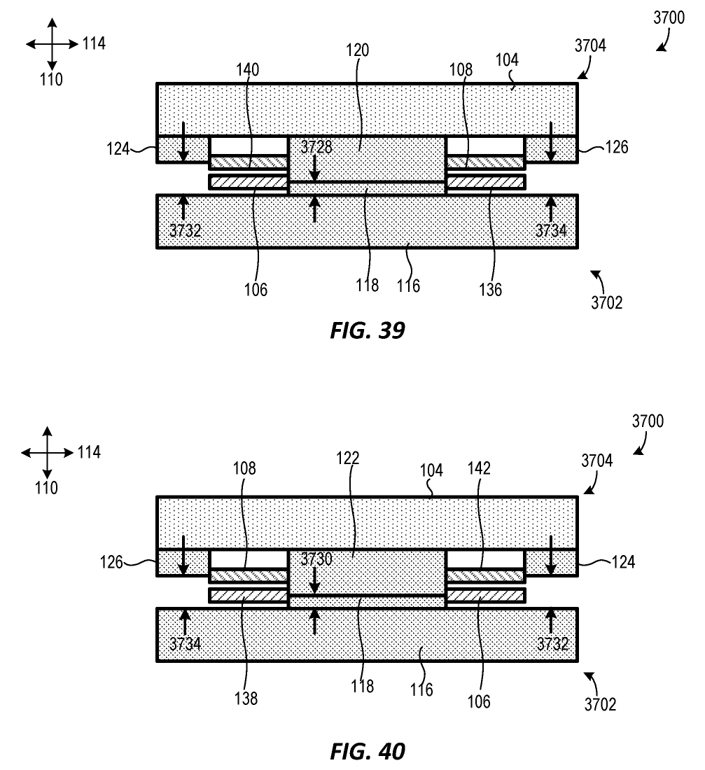

Any of the coupled inductors discussed above could be modified to move one or more magnetic elements from the base magnetic structure to the top magnetic plate, with the possible drawback of increased complexity in magnetic core fabrication. For example, FIGS. 37-40 collectively illustrate a coupled inductor 3700, which is an alternate embodiment of coupled inductor 100 where first OCL magnetic element 120, second OCL magnetic element 122, first SCL magnetic element 124, and second SCL magnetic element 126 are moved from the base magnetic structure to a top magnetic structure including a top magnetic plate. FIG. 37 is a top plan view of coupled inductor 3700, FIG. 38 is a cross-sectional view of coupled inductor 3700 taken along line I-I of FIG. 37, FIG. 39 is a front elevational view of coupled inductor 3700, and FIG. 40 is a back elevational view of coupled inductor 3700.

Coupled inductor 3700 differs from coupled inductor 100 in that (i) base magnetic structure 102 is replaced with a base magnetic structure 3702 and (ii) top magnetic plate 104 is replaced with a top magnetic structure 3704. Base magnetic structure 3702 differs from base magnetic structure 102 in that first OCL magnetic element 120, second OCL magnetic element 122, first SCL magnetic element 124, and second SCL magnetic element 126 are omitted from base magnetic structure 3702. As such, only supporting magnetic element 118 extends from base magnetic plate 116. Top magnetic structure 3702 includes top magnetic plate 104 and first OCL magnetic element 120, second OCL magnetic element 122, first SCL magnetic element 124, and second SCL magnetic element 126 extending from top magnetic plate 104 toward base magnetic plate 116 in first direction 110.

Base magnetic structure 3702 and top magnetic structure 3704 collectively form the following four gaps in the magnetic core of coupled inductor 3700: (i) a first gap 3728 separating first OCL magnetic element 120 from base magnetic plate 116 in first direction 110 (see, FIG. 39), (ii) a second gap 3730 separating second OCL magnetic element 122 from base magnetic plate 116 in first direction 110 (see, FIG. 40), (iii) a third gap 3732 separating first SCL magnetic element 124 from base magnetic plate 116 in first direction 110 (see FIGS. 38-40), and (iv) a fourth gap 3734 separating second SCL magnetic element 126 from base magnetic plate 116 in first direction 110 (see FIGS. 38-40). Each of the aforementioned gaps is filled with air or another material having a lower magnetic permeability that magnetic material forming base magnetic structure 3702 and top magnetic structure 3704. First gap 3728 and second gap 3730 serve the same purpose as first gap 128 and second gap 130, respectively, and third gap 3732 and fourth gap 3734 serve the same purpose as third gap 132 and fourth gap 134, respectively.

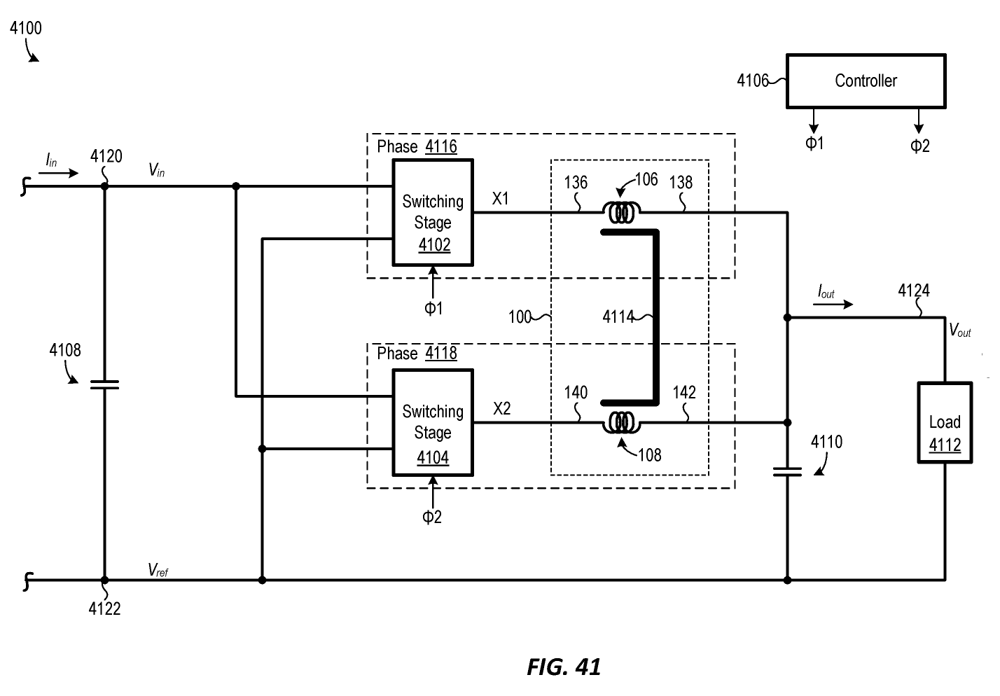

Applications of the coupled inductors disclosed herein include, but are not limited to, switching power converters, such as direct-current-to-direct current (DC-to-DC) converters. For example, FIG. 41 is a schematic diagram of a multi-phase switching power converter 4100 illustrating one possible application of coupled inductor 100. It is understood, though, that coupled inductor 100 is not limited to the FIG. 41 example application. Multi-phase switching power converter includes an instance of coupled inductor 100, a first switching stage 4102, a second switching stage 4104, a controller 4106, an input capacitor 4108, and an output capacitor 4110. FIG. 41 also depicts a load 4112 being powered by multi-phase switching power converter 4100, although load 4112 is not necessarily part of multi-phase switching power converter 4100. Coupled inductor 100 is depicted as including a magnetic core 4114 magnetically coupling first winding 106 and second winding 108, where magnetic core 4114 represents the combination of base magnetic structure 102 and top magnetic plate 104. First switching stage 4102 and first winding 106 of coupled inductor 100 collectively form a first phase 4116 of multi-phase switching power converter 4100, and second switching stage 4104 and second winding 108 of coupled inductor 100 collectively form a second phase 4118 of multi-phase switching power converter 4100.

Input capacitor 4108 is electrically coupled between an input node 4120 and a reference node 4122, and input capacitor 4108 provides a path for ripple current flowing into multi-phase switching power converter 4100. First switching stage 4102 is electrically coupled to each of input node 4120, reference node 4122, and a first switching node X1. Second switching stage 4104 is electrically coupled to each of input node 4120, reference node 4122, and a second switching node X2. First end 136 of first winding 106 is electrically coupled to first switching node X1, and second end 138 of first winding 106 is electrically coupled to an output node 4124. First end 140 of second winding 108 is electrically coupled to second switching node X2, and second end 142 of second winding 108 is electrically coupled to output node 4124. Output capacitor 4110 is electrically coupled between output node 4124 and reference node 4122, and output capacitor 4110 absorbs ripple current generated by operation of multi-phase switching power converter 4100. Output capacitor 4110 may also help support transient loads presented to multi-phase switching power converter 4100 by load 4112.

First switching stage 4102 is configured to repeatedly switch first switching node X1 between at least (i) a voltage Vᵢₙ of input node 4120 and (ii) a voltage V_{ref} of reference node 4122, under the command of one or more control signals Φ1 generated by controller 4106. Similarly, second switching stage 4104 is configured to repeatedly switch second switching node X2 between at least (i) voltage Vᵢₙ of input node 4120 and (ii) voltage V_{ref} of reference node 4122, under the command of one or more control signals Φ2 generated by controller 4106. Controller 4106 is configured to generate control signals Φ1 and control signals Φ2, for example, to regulate one of more of magnitude of voltage Vᵢₙ, magnitude of a voltage Vₒᵤₜ on output node 4124, magnitude of current I in flowing into multi-phase switching power converter 4100, and magnitude of current I out flowing out of multi-phase switching power converter 4100, such as by using a pulse width modulation (PWM) technique or a pulse frequency modulation (PFM) technique. Additionally, in some embodiments, controller 4106 is configured to generate controls Φ1 and Φ2 to cause first switching stage 4102 and second switching stage 4104 to switching out-of-phase with respect to each other, such as 180 degrees out-of-phase with respect to each other.

Multi-phase switching power converter 4100 could be modified to incorporate one of the other coupled inductors disclosed herein, such as coupled inductor 1600, 2800, or 3700, in place of coupled inductor 100. Additionally, while multi-phase switching power converter 4100 has a buck direct-current-to-direct-current (DC-to-DC) converter topology, multi-phase switching power converter 4100 could be modified to have a different topology, including but not limited to a boost DC-to-DC converter topology or a buck-boost DC-to-DC converter topology.

### Combinations of Features

Features described above may be combined in various ways without departing from the scope hereof. The following examples illustrate some possible combinations.

(A1) A coupled inductor includes a base magnetic structure, a top magnetic plate, a first winding, and a second winding. The base magnetic structure includes a base magnetic plate, a supporting magnetic element extending from the base magnetic plate in a first direction, a first open circuit inductance (OCL) magnetic element, a second OCL magnetic element, a first short circuit inductance (SCL) magnetic element, and a second SCL magnetic element. Each of the first OCL magnetic element and the second OCL magnetic element extends from the base magnetic plate in the first direction, and the first and second OCL magnetic elements are separated from each other in a second direction, where the second direction is orthogonal to the first direction. Each of the first SCL magnetic element and the second SCL magnetic element extends from the base magnetic plate in the first direction, and the first SCL magnetic element and the second SCL magnetic element are separated from each other in a third direction that is orthogonal to each of the first direction and the second direction. The top magnetic plate is disposed on the supporting magnetic element in the first direction such that the top magnetic plate is separated from each of the first OCL magnetic element, the second OCL magnetic element, the first SCL magnetic element, and the second SCL magnetic element. The first winding is wound around the supporting magnetic element, and the second winding is wound around the supporting magnetic element. The first winding and the second winding have opposing orientations when the coupled inductor is viewed cross-sectionally in the first direction.

(A2) In the coupled inductor denoted as (A1), each of the first winding and the second winding may be between the base magnetic plate and the top magnetic plate in the first direction.

(A3) In either one of the coupled inductors denoted as (A1) and (A2), the second winding may be stacked on the first winding in the first direction.

(A4) In any one of the coupled inductors denoted as (A1) through (A3), each of the first winding and the second winding may be disposed between the first SCL magnetic element and the second SCL magnetic element in the third direction.

(A5) In any one of the coupled inductors denoted as (A1) through (A4), each of the supporting magnetic element, the first OCL magnetic element, and the second OCL magnetic element may be disposed between the first SCL magnetic element and the second SCL magnetic element in the third direction.

(A6) In any one of the coupled inductors denoted as (A1) through (A5), the supporting magnetic element, the first OCL magnetic element, and the second OCL magnetic element may be disposed in a common row in the second direction.

(A7) In any one of the coupled inductors denoted as (A1) through (A6), (i) the first OCL magnetic element may be separated from the top magnetic plate in the first direction by a first gap, (ii) the second OCL magnetic element may be separated from the top magnetic plate in the first direction by a second gap, (iii) the first SCL magnetic element may be separated from the top magnetic plate in the first direction by a third gap, and (iv) the second SCL magnetic element may be separated from the top magnetic plate in the first direction by a fourth gap.

(A8) In any one of the coupled inductors denoted as (A1) through (A6), (i) the first OCL magnetic element may be separated from the top magnetic plate in the first direction by a first gap, (ii) the second OCL magnetic element may be separated from the top magnetic plate in the first direction by a second gap, (iii) the first SCL magnetic element may be separated from the top magnetic plate in the third direction by a third gap, and (iv) the second SCL magnetic element may be separated from the top magnetic plate in the third direction by a fourth gap.

(A9) In any one of the coupled inductors denoted as (A1) through (A8), (i) the first winding may include a first extension extending over the top magnetic plate, such that the top magnetic plate is disposed between the first extension and the base magnetic plate, in the first direction, and (ii) the second winding may include a second extension extending over the top magnetic plate, such that the top magnetic plate is disposed between the second extension and the base magnetic plate, in the first direction.

(A10) In any one of the coupled inductors denoted as (A1) through (A8), (i) t he first winding may include a first electrical conductor of a printed circuit board (PCB) and (ii) the second winding may include a second electrical conductor of the PCB.

(B1) A coupled inductor incudes a base magnetic plate, a supporting magnetic element extending from the base magnetic plate in a first direction, a top magnetic plate disposed on the supporting magnetic element in the first direction, a first open circuit inductance (OCL) magnetic element, a second OCL magnetic element, a first short circuit inductance (SCL) magnetic element, a second SCL magnetic element, a first winding, and a second winding. Each of the first OCL magnetic element and the second OCL magnetic element is disposed between the base magnetic plate and the top magnetic plate in the first direction, and each of the first OCL magnetic element and the second OCL magnetic element is separated from one of the base magnetic plate and the top magnetic plate in the first direction. The first and second OCL magnetic elements are separated from each other in a second direction, the second direction being orthogonal to the first direction. Each of the first SCL magnetic element and the second SCL magnetic element are disposed between the base magnetic plate and the top magnetic plate in the first direction, and each of the first SCL magnetic element and the second SCL magnetic element is separated from one of the base magnetic plate and the top magnetic plate in the first direction. The first SCL magnetic element and the second SCL magnetic element are separated from each other in a third direction that is orthogonal to each of the first direction and the second direction. The first winding is wound around the supporting magnetic element, and the second winding is wound around the supporting magnetic element. The first winding and the second winding have opposing orientations when the coupled inductor is viewed cross-sectionally in the first direction.

(B2) In the coupled inductor denoted as (B1), each of the first winding and the second winding may be disposed between the base magnetic plate and the top magnetic plate in the first direction.

(B3) In either one of the coupled inductors denoted as (B1) and (B2), each of the first winding and the second winding may be disposed between the first SCL magnetic element and the second SCL magnetic element in the third direction.

(C1) A multi-phase switching power converter includes a first switching stage, a second switching stage, and a coupled inductor. The coupled inductor includes a base magnetic structure, a top magnetic plate, a first winding, and a second winding. The base magnetic structure includes a base magnetic plate, a supporting magnetic element extending from the base magnetic plate in a first direction, a first open circuit inductance (OCL) magnetic element, a second OCL magnetic element, a first short circuit inductance (SCL) magnetic element. and a second SCL magnetic element. Each of the first OCL magnetic element and the second OCL magnetic element extends from the base magnetic plate in the first direction, and the first and second OCL magnetic elements are separated from each other in a second direction, where the second direction is orthogonal to the first direction. Each of the first SCL magnetic element and the second SCL magnetic element extends from the base magnetic plate in the first direction, and the first SCL magnetic element and the second SCL magnetic element are separated from each other in a third direction that is orthogonal to each of the first direction and the second direction. The top magnetic plate is disposed on the supporting magnetic element in the first direction such that the top magnetic plate is separated from each of the first OCL magnetic element, the second OCL magnetic element, the first SCL magnetic element, and the second SCL magnetic element. The first winding is wound around the supporting magnetic element, and a first end of the first winding is electrically coupled to the first switching stage. The second winding is wound around the supporting magnetic element, and a first end of the second winding is electrically coupled to the second switching stage. The first winding and the second winding have opposing orientations when the coupled inductor is viewed cross-sectionally in the first direction.

(C2) In the multi-phase switching power converter denoted as (C1), each of the first winding and the second winding may be disposed between the base magnetic plate and the top magnetic plate in the first direction.

(C3) In either one of the multi-phase switching power converters denoted as (C1) and (C2), each of the first winding and the second winding may be disposed between the first SCL magnetic element and the second SCL magnetic element in the third direction.

(C4) In any one of the multi-phase switching power converters denoted as (C1) through (C3), each of the supporting magnetic element, the first OCL magnetic element, and the second OCL magnetic element may be disposed between the first SCL magnetic element and the second SCL magnetic element in the third direction.

(C5) In any one of the multi-phase switching power converters denoted as (C1) through (C4), the supporting magnetic element, the first OCL magnetic element, and the second OCL magnetic element may be disposed in a common row in the second direction.

(C6) In any one of the multi-phase switching power converters denoted as (C1) through (C5), (i) the first OCL magnetic element may be separated from the top magnetic plate in the first direction by a first gap, (ii) the second OCL magnetic element may be separated from the top magnetic plate in the first direction by a second gap, (iii) the first SCL magnetic element may be separated from the top magnetic plate in the first direction by a third gap, and (iv) the second SCL magnetic element may be separated from the top magnetic plate in the first direction by a fourth gap.

(C7) In any one of the multi-phase switching power converters denoted as (C1) through (C5), (i) the first OCL magnetic element may be separated from the top magnetic plate in the first direction by a first gap, (ii) the second OCL magnetic element may be separated from the top magnetic plate in the first direction by a second gap, (iii) the first SCL magnetic element may be separated from the top magnetic plate in the third direction by a third gap, and (iv) the second SCL magnetic element may be separated from the top magnetic plate in the third direction by a fourth gap.

Changes may be made in the above methods, devices, and systems without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and system, which as a matter of language, might be said to fall therebetween.

What is claimed is:

1. A coupled inductor, comprising:
a base magnetic structure, including:
a base magnetic plate,
a supporting magnetic element extending from the base magnetic plate in a first direction,
a first open circuit inductance (OCL) magnetic element and a second OCL magnetic element, each of the first OCL magnetic element and the second OCL magnetic element extending from the base magnetic plate in the first direction, the first and second OCL magnetic elements being separated from each other in a second direction, the second direction being orthogonal to the first direction, and
a first short circuit inductance (SCL) magnetic element and a second SCL magnetic element, each of the first SCL magnetic element and the second SCL magnetic element extending from the base magnetic plate in the first direction, the first SCL magnetic element and the second SCL magnetic element being separated from each other in a third direction that is orthogonal to each of the first direction and the second direction;
a top magnetic plate disposed on the supporting magnetic element in the first direction such that the top magnetic plate is separated from each of the first OCL magnetic element, the second OCL magnetic element, the first SCL magnetic element, and the second SCL magnetic element;
a first winding wound around the supporting magnetic element; and
a second winding wound around the supporting magnetic element, the first winding and the second winding having opposing orientations when the coupled inductor is viewed cross-sectionally in the first direction.

2. The coupled inductor of claim 1, wherein each of the first winding and the second winding is disposed between the base magnetic plate and the top magnetic plate in the first direction.

3. The coupled inductor of claim 1, wherein the second winding is stacked on the first winding in the first direction.

4. The coupled inductor of claim 1, wherein each of the first winding and the second winding is disposed between the first SCL magnetic element and the second SCL magnetic element in the third direction.

5. The coupled inductor of claim 1, wherein each of the supporting magnetic element, the first OCL magnetic element, and the second OCL magnetic element is disposed between the first SCL magnetic element and the second SCL magnetic element in the third direction.

6. The coupled inductor of claim 1, wherein the supporting magnetic element, the first OCL magnetic element, and the second OCL magnetic element are disposed in a common row in the second direction.

7. The coupled inductor of claim 1, wherein:
the first OCL magnetic element is separated from the top magnetic plate in the first direction by a first gap;
the second OCL magnetic element is separated from the top magnetic plate in the first direction by a second gap;
the first SCL magnetic element is separated from the top magnetic plate in the first direction by a third gap; and
the second SCL magnetic element is separated from the top magnetic plate in the first direction by a fourth gap.

8. The coupled inductor of claim 1, wherein:
the first OCL magnetic element is separated from the top magnetic plate in the first direction by a first gap;
the second OCL magnetic element is separated from the top magnetic plate in the first direction by a second gap;
the first SCL magnetic element is separated from the top magnetic plate in the third direction by a third gap; and
the second SCL magnetic element is separated from the top magnetic plate in the third direction by a fourth gap.

9. The coupled inductor of claim 1, wherein:
the first winding includes a first extension extending over the top magnetic plate, such that the top magnetic plate is disposed between the first extension and the base magnetic plate, in the first direction; and
the second winding includes a second extension extending over the top magnetic plate, such that the top magnetic plate is disposed between the second extension and the base magnetic plate, in the first direction.

10. The coupled inductor of claim 1, wherein:
the first winding includes a first electrical conductor of a printed circuit board (PCB); and
the second winding includes a second electrical conductor of the PCB.

11. A coupled inductor, comprising:
a base magnetic plate;
a supporting magnetic element extending from the base magnetic plate in a first direction;
a top magnetic plate disposed on the supporting magnetic element in the first direction;
a first open circuit inductance (OCL) magnetic element and a second OCL magnetic element, each of the first OCL magnetic element and the second OCL magnetic element being disposed between the base magnetic plate and the top magnetic plate in the first direction, each of the first OCL magnetic element and the second OCL magnetic element being separated from one of the base magnetic plate and the top magnetic plate in the first direction, the first and second OCL magnetic elements being separated from each other in a second direction, the second direction being orthogonal to the first direction;
a first short circuit inductance (SCL) magnetic element and a second SCL magnetic element, each of the first SCL magnetic element and the second SCL magnetic element being disposed between the base magnetic plate and the top magnetic plate in the first direction, each of the first SCL magnetic element and the second SCL magnetic element being separated from one of the base magnetic plate and the top magnetic plate in the first direction, the first SCL magnetic element and the second SCL magnetic element being separated from each other in a third direction that is orthogonal to each of the first direction and the second direction;
a first winding wound around the supporting magnetic element; and
a second winding wound around the supporting magnetic element, the first winding and the second winding having opposing orientations when the coupled inductor is viewed cross-sectionally in the first direction.

12. The coupled inductor of claim 11, wherein each of the first winding and the second winding is disposed between the base magnetic plate and the top magnetic plate in the first direction.

13. The coupled inductor of claim 11, wherein each of the first winding and the second winding is disposed between the first SCL magnetic element and the second SCL magnetic element in the third direction.

14. A multi-phase switching power converter, comprising:
a first switching stage;
a second switching stage;
a coupled inductor, including:
a base magnetic structure, including:
a base magnetic plate,
a supporting magnetic element extending from the base magnetic plate in a first direction,
a first open circuit inductance (OCL) magnetic element and a second OCL magnetic element, each of the first OCL magnetic element and the second OCL magnetic element extending from the base magnetic plate in the first direction, the first and second OCL magnetic elements being separated from each other in a second direction, the second direction being orthogonal to the first direction, and
a first short circuit inductance (SCL) magnetic element and a second SCL magnetic element, each of the first SCL magnetic element and the second SCL magnetic element extending from the base magnetic plate in the first direction, the first SCL magnetic element and the second SCL magnetic element being separated from each other in a third direction that is orthogonal to each of the first direction and the second direction,
a top magnetic plate disposed on the supporting magnetic element in the first direction such that the top magnetic plate is separated from each of the first OCL magnetic element, the second OCL magnetic element, the first SCL magnetic element, and the second SCL magnetic element,
a first winding wound around the supporting magnetic element, a first end of the first winding being electrically coupled to the first switching stage, and
a second winding wound around the supporting magnetic element, a first end of the second winding being electrically coupled to the second switching stage, the first winding and the second winding having opposing orientations when the coupled inductor is viewed cross-sectionally in the first direction.

15. The multi-phase switching power converter of claim 14, wherein each of the first winding and the second winding is disposed between the base magnetic plate and the top magnetic plate in the first direction.

16. The multi-phase switching power converter of claim 14, wherein each of the first winding and the second winding is disposed between the first SCL magnetic element and the second SCL magnetic element in the third direction.

17. The multi-phase switching power converter of claim 14, wherein each of the supporting magnetic element, the first OCL magnetic element, and the second OCL magnetic element is disposed between the first SCL magnetic element and the second SCL magnetic element in the third direction.

18. The multi-phase switching power converter of claim 14, the supporting magnetic element, the first OCL magnetic element, and the second OCL magnetic element are disposed in a common row in the second direction.

19. The multi-phase switching power converter of claim 14, wherein:
the first OCL magnetic element is separated from the top magnetic plate in the first direction by a first gap;
the second OCL magnetic element is separated from the top magnetic plate in the first direction by a second gap;
the first SCL magnetic element is separated from the top magnetic plate in the first direction by a third gap; and
the second SCL magnetic element is separated from the top magnetic plate in the first direction by a fourth gap.

20. The multi-phase switching power converter of claim 14, wherein:
the first OCL magnetic element is separated from the top magnetic plate in the first direction by a first gap;
the second OCL magnetic element is separated from the top magnetic plate in the first direction by a second gap;
the first SCL magnetic element is separated from the top magnetic plate in the third direction by a third gap; and
the second SCL magnetic element is separated from the top magnetic plate in the third direction by a fourth gap.
